(19) United States
(12) Patent Application Publication
(10) Pub. No.: US 2010/0014797 A1
(43) Pub. Date: Jan. 21, 2010

(54) RADIAL ROLLER BEARING, IN PARTICULAR FOR STORING SHAFTS IN WIND TURBINE TRANSMISSIONS

(75) Inventors: Bernd Endres, Roethlein (DE); Christian Hoffinger, Georgensgmuend (DE); Tobias Mueller, Dipperz (DE); Witold Marek Smolenski, Schweinfurt (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/515,809

(22) PCT Filed: Nov. 15, 2007
(86) PCT No.: PCT/DE2007/002069

§ 371 Date: Aug. 26, 2009

(30) Foreign Application Priority Data
Nov. 22, 2006 (DE) 10 2006 055 029.3

(51) Int. Cl. F16C 19/24

(52) U.S. Cl. 384/548

(57) ABSTRACT

A radial roller bearing for storing shafts in wind turbine transmissions, which has an external bearing ring with an inner runway, an internal bearing ring arranged coaxial thereto provided with an external runway, and a plurality of roller bodies that displace on the runways between the bearing rings held at regular intervals by a bearing cage. to prevent slip, roller bodies are replaced by hollow rollers that have a greater diameter and a smaller elasticity module than the roller body bodies ensuring, when the radial roller bearing is in the load-free state, a permanent contact with the bearing rings, and a permanent drive of the bearing cage and the roller bodies have kinematic rotation. The hollow rollers, by a defined dimensioning of their internal diameter in relation to their external diameter for the dimensioning of the radial roller bearing, have the same bearing capacity as the roller bodies.

### FIELD OF THE INVENTION

The invention relates to a radial roller bearing according to the features which form the preamble of patent claim 1, and it can be implemented particularly advantageously on bearings which run at a very low load at least at times, for example for the bearing of shafts in wind power transmissions.

### BACKGROUND TO THE INVENTION

A person skilled in the art of roller bearing technology will, in general, be aware that radial roller bearings have an optimum kinematic operating state when sufficiently loaded, at which the roller bodies roll on the raceways of the inner and of the outer bearing ring, without sliding. Furthermore, in the case of radial roller bearings which are operated on low loads at least at times, it is known that the roller body set which comprises the roller bodies and their bearing cage does not rotate at the kinematic rotation speed because of the friction in the bearing or because of the high mass force of the roller body set and the contact force, which is small at times, between the roller bodies and the raceways. In consequence, the rotation speed of the roller body set is less than the kinematic rotation speed, so that the roller bodies are in a kinematically non-optimum state, as a result of which slip occurs between these roller bodies and at least one raceway. In this case, a lubricating film can be formed on the contact surfaces between the roller bodies and the raceway. However, the lubrication film is destroyed in the event of a sudden change in the rotation speed or load, as a result of which there will no longer be an adequate lubricating film within a very short time at the contact points where the slip occurs. This results in a metallic contact between the raceway and the roller bodies, which slide on the raceway until the roller bodies are accelerated to the kinematic rotation speed. This large speed difference between the raceway and the roller bodies, as well as the lack of a separating lubricating film therefore results in high tangential stresses in the surfaces of the raceway and of the roller bodies, which are associated with very severe wear, such as roughening of the raceways, material being torn off and rubbing marks, generally in conjunction with micropitting, thus leading to premature failure of the radial roller bearing.

A radial roller bearing of this generic type has therefore been proposed in FR 2 479 369, which essentially comprises an outer bearing ring with an inner raceway and an inner bearing ring which is arranged coaxially with respect thereto and has an outer raceway, as well as a multiplicity of roller bodies which roll between the bearing rings on their raceways and are held at uniform distances from one another in the circumferential direction by a bearing cage, in which a plurality of roller bodies which are distributed uniformly on the circumference between the roller bodies and the bearing rings, are replaced by hollow rollers in order to avoid the described slip effect and the resulting disadvantages. These hollow rollers, which are also axially somewhat shorter than the other roller bodies, in this case have a slightly larger diameter and a lower modulus of elasticity than the other roller bodies, as a result of which, in the load-free state of the radial roller bearing, they make continuous contact with the bearing rings and, therefore, ensure a continuous drive of the bearing cage and, thus, of the other roller bodies at the kinematic rotation speed.

However, in practice, it has been found that the hollow rollers, which are subject to continuous bending fatigue load as a result of their permanent deformation, in radial roller bearings such as these represent potential weak points in terms of their load capability, thus resulting in reduced load-carrying capability and a shorter life of the roller bearing. For example, it has been found that, when the internal diameter is designed to be excessively large in comparison to the external diameter of the hollow rollers, that is to say when the wall thicknesses of the hollow rollers are too thin, this results in a major decrease in the load capability of the hollow rollers, and, therefore, in an increase in the load on the other roller bodies, at the design point of the radial roller bearing, which would lead to premature wear of these roller bodies and therefore to shortening of the service life of the radial roller bearing. When, in contrast, the internal diameter is made too small in comparison to the external diameter of the hollow rollers, that is to say the wall thickness of the hollow rollers is chosen to be too great, at the design point of the radial roller bearing, this leads to peak loads on the hollow rollers, which peak loads would lead to cracks during continuous operation of the bearing, and finally to fracture of the hollow rollers, and, therefore, likewise to shortening of the service life of the radial roller bearing. One obvious measure to avoid such design errors would admittedly be to increase the overall dimensions of both the hollow rollers and the other roller bodies, but this would necessarily result in a disadvantageous increase in the total space required for the bearing and an increase in the production costs for the roller bearing.

### OBJECT OF THE INVENTION

Against the background of the described disadvantages of the known prior art, the invention is therefore based on the object of designing a radial roller bearing, in particular for the bearing of shafts in wind power transmissions, which, while greatly retaining its original performance features, such as the load capacity, installation space and service life, is equipped with hollow rollers in order to avoid slip between the roller bodies and the bearing rings, which hollow rollers withstand the bearing loads that occur at all times, avoid overloading of the other roller bodies, and therefore increase the useful life of the radial roller bearing.

### DESCRIPTION OF THE INVENTION

According to the invention, in the case of a radial roller bearing as claimed in the preamble of claim 1, this object is achieved in that the hollow rollers have the same or approximately the same load capability as the other roller bodies, by means of a defined design of their internal diameter with respect to their external diameter at the design point of the radial roller bearing.

The invention is therefore based on the realization that, just by deliberate design of the ratio between the internal diameter and the external diameter of the hollow rollers, it is possible to avoid not only the peak loads on the hollow rollers themselves but also the premature wear of the other roller bodies, and, therefore, to critically increase the load capability and the life of such radial roller bearings.

Furthermore, as claimed in claim 2, in one particularly advantageous refinement of the radial roller bearing designed according to the invention, the hollow rollers have the same axial length as the other roller bodies, and the size of their internal diameter is between 60% and 80%, preferably 70±3%, of the size of their external diameter. Designing the hollow rollers to have the same axial length as the other roller bodies in this case makes a further contribution to approximating the load capability of the hollow rollers to the load capability of the other roller bodies in the radial roller bearing, while the size of their internal diameter of 70±3% of the size of their external diameter represents an optimum with regard to all the load conditions which occur during continuous operation of the radial roller bearing.

The radial roller bearing designed according to the invention therefore has the advantage over the radial roller bearings that are known from the prior art that, while greatly retaining its original performance features, such as load capacity, installation space and service life, in order to avoid slip between the roller bodies and the bearing rings, the radial roller bearing is equipped with hollow rollers, which withstand the occurring bearing loads at all times and at the same time avoid overloading of the other roller bodies by deliberately setting the ratio between their internal diameter and their external diameter. These advantages are in this case achieved even if the roller bodies are guided by a bearing cage but guide themselves, as in the case of fully rolling bearings.

### BRIEF DESCRIPTION OF THE DRAWINGS

One preferred embodiment of the radial roller bearing designed according to the invention will be explained in more detail in the following text with reference to the attached drawings, in which:

FIG. 1 shows a side view of a radial roller bearing designed according to the invention; and

FIG. 2 shows the cross section A-A through the radial roller bearing designed according to the invention, as shown in FIG. 1.

### DETAILED DESCRIPTION OF THE DRAWINGS

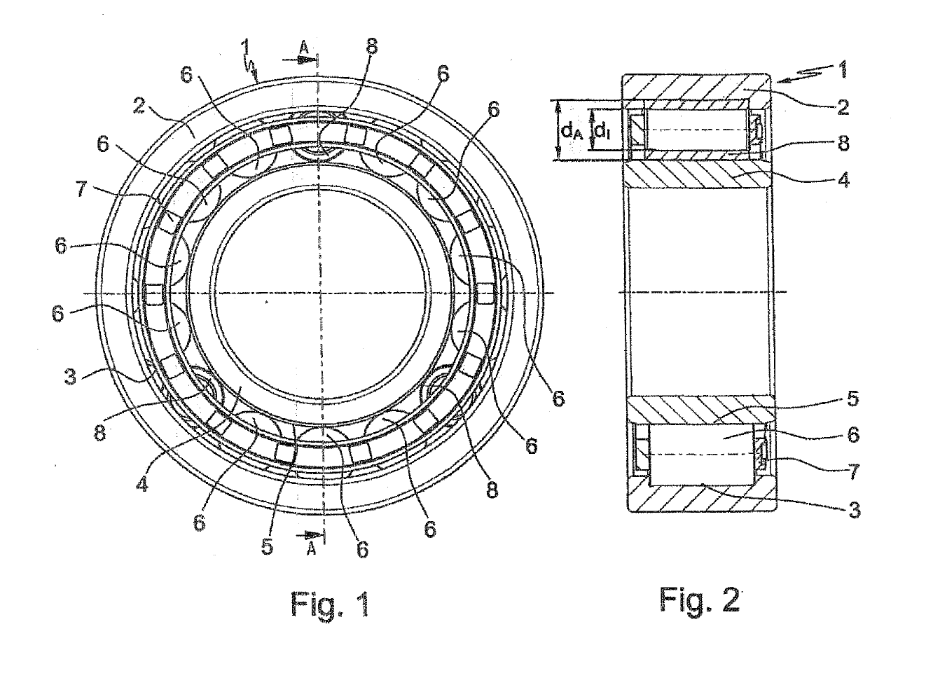

The illustrations in FIGS. 1 and 2 clearly show a radial roller bearing 1, which is suitable for the bearing of shafts in wind power transmissions, and, in a known manner, comprises an outer bearing ring 2 with an inner raceway 3 and an inner bearing ring 4, which is arranged coaxially with respect thereto and has an outer raceway 5, as well as a multiplicity of roller bodies 6, which roll between the bearing rings 2, 4 on their raceways 3, 5 and are held at uniform distances from one another in the circumferential direction by a bearing cage 7. The drawings likewise clearly show that, in the case of the illustrated radial roller bearing 1, three roller bodies 6, which are distributed uniformly on the circumference, are replaced by hollow rollers 8 in order to avoid slip between the roller bodies 6 and the bearing rings 2, 4, which hollow rollers 8 have a slightly larger diameter and a lower modulus of elasticity than the other roller bodies 6, in order to ensure, in the load-free state of the radial roller bearing 1, a continuous contact with the bearing rings 2, 4 and thus a continuous drive for the bearing cage 7 and thus for the other roller bodies 6 at a kinematic rotation speed.

In order that peak loads no longer occur on the hollow rollers 8 themselves, which could lead to fracture of the hollow rollers 8 during continuous operation of the radial roller bearing 1, and in order to avoid overloading of the other roller bodies 6, which would cause premature wear, the hollow rollers 8 are developed in a manner according to the invention by a defined design of their internal diameter d_{I} with respect to their external diameter d_{A} at the design point of the radial roller bearing 1 with the same or approximately the same load capability as the other roller bodies 6. This is achieved in that the hollow rollers 8 have the same axial length as the other roller bodies 6 and the size of their internal diameter d_{I} is preferably 70±3% of the size of their external diameter d_{A}.

### LIST OF REFERENCE SYMBOLS

1 Radial roller bearing

2 Outer bearing ring

3 Inner raceway

4 Inner bearing ring

5 Outer raceway

6 Roller body

7 Bearing cage

8 Hollow rollers

d_{I} Inner diameter

d_{A} External diameter

1. A radial roller bearing for a bearing of shafts in wind power transmissions, comprising:
an outer bearing ring having an inner raceway; and
an inner bearing ring being arranged coaxially with respect thereto having an outer raceway; and
a multiplicity of roller bodies rolling between the outer bearing ring and the inner bearing ring on the inner raceway and the outer raceway being held at uniform distances from one another in a circumferential direction by a bearing cage, the roller bodies being replaced by hollow rollers to avoid slip between the roller bodies and the outer bearing ring and the inner bearing ring, the hollow rollers having a slightly larger diameter and a lower modulus of elasticity than the roller bodies ensuring, in a load-free state of the radial roller bearing, a continuous contact with the outer bearing ring and the inner bearing ring and a continuous drive for the bearing cage and for the roller bodies at a kinematic rotation speed,
wherein the hollow rollers have a same load capability as the roller bodies, by means of a defined design of their internal diameter with respect to their external diameter at a design point of the radial roller bearing.

2. The radial roller bearing of claim 1, wherein the hollow rollers have a same axial length as the roller bodies, and the internal diameter of the hollow rollers is between 60% and 80% of the hollow rollers external diameter.
